(19) United States
(12) Patent Application Publication
(10) Pub. No.: US 2016/0108320 A1
(43) Pub. Date: Apr. 21, 2016

(54) METHOD FOR TREATING OIL SANDS AND DEVICE FOR IMPLEMENTING SUCH A METHOD

(71) Applicants: SEPAREX, Champigneulles (FR); TOTAL SA, Courbevoie (FR)

(72) Inventors: Christophe Halais, Lons (FR); Jacques Bousquet, Irigny (FR); Michel Jean Baptiste; Perrut, Villers Les Nancy (FR)

(73) Assignee: TOTAL SA, Courbevoie (FR)

(21) Appl. No.: 14/893,435

(22) PCT Filed: May 20, 2014
(86) PCT No.: PCT/FR2014/051179

§ 371 Date: Nov. 23, 2015

(30) Foreign Application Priority Data
May 23, 2013 (FR) 13 54658

(51) Int. Cl. C10G 1/04; B03B 9/02

(52) U.S. Cl. CPC C10G 1/045; B03B 9/02

(57) ABSTRACT

The invention relates to a method for treating oil sand. The steps consisting of cooling said oil sand to a temperature lower than the glass transition temperature of the bitumen by bringing said oil sand into contact with carbon dioxide in the solid state and applying mechanical energy to the mixture produced. Then melting the solid carbon dioxide in such a way as to produce a multiphase system. The multiphase system is then separated into at least one solid phase and at least one liquid phase. The bituminous phase is then recovered from the separated liquid phase. The invention also relates to a device for treating oil sand, especially designed for implementing said method.

### RELATED APPLICATIONS

The present application is a National Phase entry of PCT Application No. PCT/FR2014/051179, filed May 20, 2014, which claims priority from FR Patent Application No. 13 54658, filed May 23, 2013, said applications being hereby incorporated by reference herein in their entirety.

### FIELD OF THE INVENTION

The field of the invention is the treatment of oil sands. The invention relates in particular to a method for treating oil sands using carbon dioxide firstly in solid form and then in liquid form. The invention also relates to devices for implementing such a method.

### BACKGROUND OF THE INVENTION

Oil sands (also called “tar sands” or “bituminous sands”) are hydrocarbon reserves consisting of a mixture of heavy oils degraded to bitumens and inorganic matter. Typically, oil sand has a bitumen content in the range from 5% to 20% (by weight). The inorganic matter essentially consists of sand, but it may also contain other mineral compounds, such as clays, and water. In order to upgrade the bitumen contained in oil sands, it is necessary to separate it from the inorganic phase.

A conventional method for exploiting these reserves is extraction in strip mines: the oil sand is excavated, and the bitumens are then separated from the sand by washing. These washing operations consume a lot of water, which has a considerable ecological impact despite the considerable use of water recycling, since the used water is discharged and held in tailings ponds, which is intended to purify the water prior to its discharge to the environment.

Massive amounts of hot water with addition of soda and additives are used. These conventional techniques pose major environmental problems. For example, large-scale lagooning is currently employed with the wastewaters from the bitumen extraction installations in Alberta, Canada. These wastewaters, poured into vast artificial ponds covering several square kilometers, were the subject of a first environmental directive specific to Canada (Directive 074 approved by the “Energy Resources Conservation Board of Alberta” on Feb. 3, 2009), following the controversy engendered essentially by nongovernmental organizations. Thus, problems of water resources, large-scale lagooning of wastewaters and general degradation of biodiversity call into question the exploitation of oil sands by the conventional techniques of strip mining.

Alternative techniques using little or no water are known.

A first alternative technique that was the subject of an earlier study by researchers at the UWO University, London Ontario, is cryogenic extraction of oil sands. The technique used is based on a known physical principle: the bitumen fraction of the ore becomes brittle at a temperature below the glass transition temperature “T_{g}” of bitumen. The glass transition temperature of bitumen is between −15° C. and −40° C., and is conventionally put at about −20° C. Exposed to its glass transition temperature or lower temperatures, the bitumen fraction of an oil sand then breaks up into fine particles, which are then recovered. This method is conventionally called cryogenic recovery (or enrichment). Cryogenic extraction may be combined with a step of mechanical grinding. This method is then conventionally called enrichment by cryogenic grinding.

A particular technique of cryogenic grinding was described by Welmers et al. in the work “Cryogenic recovery of tar from Athabasca tar sands”, A. Welmers, M. A. Bergougnou, G. J. Baker, Canadian Journal of Chemical Engineering, Vol. 56, pages 99-102, 1978. This technique consists of combining grinding of frozen oil sand in a ball mill, in which the balls scrape the surface of a fluidization grid, and attrition (or elutriation) produced by a fluidized bed, into which the oil sand is introduced continuously and fluidized by cooled gaseous nitrogen. Cooling is obtained by heat exchange of the gaseous nitrogen with liquid dinitrogen. A major drawback of the technique developed by Welmers et al. is that, although the bitumen recovery rate is about 90%, the extraction results are limited in performance. In fact, from 100 tonnes of dry oil sand containing 14% of bitumen and 86% of inorganic matter, this technique, according to Welmers et al., only gives 21 tonnes of enriched product still containing 40% of mineral, and 60% of bitumen. The end product of extraction, although enriched in bitumen, therefore contains a proportion of inorganic matter that is still too high to make this technique a satisfactory alternative to extraction by washing.

Other methods of cryogenic grinding have been proposed, also based on combining low-temperature treatment and mechanical treatment.

Thus, patent application WO 2011/097735 describes a method of cryogenic grinding comprising the following sequence of unit operations:
making pellets by agglomeration of oil sand;
cooling and maintaining the pellets at low temperature to prevent any agglomeration thereof, for example using a cold-gas cooling tower,
cooling the pellets to a temperature below the glass transition temperature of bitumen and grinding the pellets at this temperature;
separation of the bitumen in a separator.

In this method, grinding may be carried out dry or in a liquid medium, notably in the presence of liquid glycol.

The practical benefit of this method is limited, in that it consists firstly of agglomerating oil sand, and then grinding the agglomerates obtained, which constitutes two unit operations with mutually opposing purposes, both of which are expensive in energy and equipment.

Another method of enrichment by cryogenic grinding is also described in Canadian patent application CA 2738011. This method also aims to facilitate rupture between the bitumen and the inorganic matter by fragmenting the bitumen fraction of the oil sand at low temperature. A sequence of unit operations that is well known from the prior art, all carried out at low temperature, is also employed in this method. The latter begins with two grinding steps, which end in conventional sieving, generating two streams of particles of different size: a fine particle stream, and a coarse particle stream. The coarse particle stream then undergoes additional grinding, which produces an additional amount of fine particles, which are added to the initial main stream of fine particles. As the latter still have an appreciable content of inorganic matter, this stream of particles with diameter typically below 5 or 10 μm is submitted to two mechanical separation operations, used conventionally in powder technology, using a zigzag impactor and an induced vortex separator, the device employed being supplemented finally with an electrostatic dust separator.

Like the method disclosed in application WO 2011/097735, the method according to CA 2738011 is an entirely mechanical, strictly gas/solid method, in which a low temperature is maintained by permanent circulation of cold gas. Said method is characterized by great complexity, which is necessarily a source of various malfunctions, and consequently involves high costs in terms of application, for example connected with high energy consumption and with probable deficiencies of operational reliability. Moreover, handling of dry, combustible powders presents severe risks in terms of industrial safety.

Moreover, patent application US 2011/0297586 describes a method for separating bitumen from oil sand by enrichment by cryogenic grinding, without using a solvent. It is a method that is purely mechanical and strictly gas/solid, like those described above. This document mentions the possibility of cooling oil sand using cold air, carbon dioxide that is solid, liquid under pressure or gaseous, or liquid nitrogen. However, when liquid carbon dioxide is used, patent application US 2011/0297586 states that the latter is transformed on contact with the oil sand into a mixture of solid and gaseous carbon dioxide, and that the solid carbon dioxide then sublimes during mixing. This document therefore only suggests using carbon dioxide temporarily, only for cooling the oil sand as quickly as possible. Once this cooling has been carried out, the method described in US 2011/0297586 follows a sequence of steps identical to those described in WO 2011/097735 or CA 2738011, during which the operations do not employ any separating fluid of a liquid nature such as liquid CO₂. Quite the opposite, the method of extraction described in the three patents cited above appears very precisely as a strictly gas/solid method, not involving any separating fluid of a liquid nature.

The techniques of cryogenic grinding described in WO 2011/097735, CA 2738011 and US 2011/0297586 mentioned above, which lead to the production of a fraction enriched in bitumen relative to the initial oil sand, have various important drawbacks. On the one hand, enrichment by cryogenic grinding carried out by these methods is unable to give a mineral-free bitumen with a satisfactory yield of material and satisfactory energy efficiency, which necessitates employing subsequent treatments to obtain a hydrocarbon phase free from mineral compounds. Moreover, it is known that the techniques of cryogenic grinding are very sensitive to the nature of the oil sand treated. In fact, these techniques offer very limited reliability owing to the variations of the materials of mining origin to be treated, notably the variations in composition and mechanical, rheological or physicochemical behavior, connected with the site and with the conditions of mining exploitation employed. It is also known that the operations described in these three patents (grinding and fine sieving, zigzag impactors, induced vortex separator, cyclones in cascades, filters or electrostatic separators) are not suited to ore treatment capacities with very high tonnage and are only carried out industrially to produce small tonnages of very clean (nonsticky) products with high added value.

Other techniques for extracting the bituminous fraction from oil sands, based on the use of solvents in combination with a cold method, are known.

U.S. Pat. No. 3,993,555 describes a technique that comprises bringing oil sands, derived from strip mining, into contact with a solvent of bitumen having a melting point below the melting point of water, notably toluene. During this operation, the solvent is cooled to a temperature sufficient to freeze water but not the solvent, which makes it possible to obtain a liquid/solid mixture, which is treated downstream, where the liquid is a solution of bitumen and solvent, and where the solid phase consists of sand and ice. This mixture, still held at low temperature, is then submitted to separation by filtration and/or centrifugation. The liquid phase, comprising the bitumen and the solvent, is recovered, then heated and submitted to conventional distillation, in order to separate the bitumen. The solvent distilled may be returned upstream of the extraction chain, to be mixed with oil sands again. Despite its complexity, this method has limited performance since, according to the example in U.S. Pat. No. 3,993,555, the recovery rate is only 91%. Moreover, its energy consumption is considerable owing to the large amounts of solvent used. In addition, it has the major drawback of using an organic solvent that is potentially harmful and ecotoxic, which greatly limits the interest in the method.

U.S. Pat. No. 4,498,971 discloses another method of extracting bitumen from oil sands, combining cryogenic grinding using solvents for separating the bitumen and the sand. This method consists of cooling the oil sand, to a temperature between −10° C. and −180° C., preferably about −60° C., and submitting it to grinding combined with sieving of the resultant solid, with a mesh of 150 μm. Once sieved, the ground oil sand is in the form of two granulometry classes respectively below and above 150 μm. These two classes go through two separate routes of treatment using solvents. The heavy fraction, of granulometry above 150 μm, is mixed with n-hexane and leads to a bitumen being obtained, probably deasphalted, and at the same time obtaining a pitch, which is separated by filtration. The light fraction, of granulometry below 150 μm, is also mixed with n-hexane. Sand mixed with pitch is produced at decanter bottom, and a liquid concentrates at decanter top, which has to be filtered, in order to separate the mixture consisting of “polar hydrocarbons” and pitch, from a liquid made up of deasphalted oil and n-hexane. The deasphalted oil/n-hexane liquid is then distilled with a view to recovering the solvent n-hexane, derived from treatment of the light fraction, for total recycling. Downstream of these specific treatments of the heavy and light fractions, the two fractions of deasphalted bitumen are mixed in line and submitted to final deasphalting, carried out using a second solvent, which is n-pentane. Such a method is undeniably complex: the whole of the method is carried out at low temperature, employs three deasphalting units, a cryogenic coarse grinding mill, a sieving step, filtration steps with at least three large-capacity filters, and uses two paraffinic solvents, which must be recovered and recycled. This results in a very expensive method, both in capital investment and in terms of energy, and whose performance in carbon yield relative to the bitumen of the oil sand is unsatisfactory.

Therefore the technologies for extracting bitumen from oil sands described above do not lead to satisfactory results, in terms of bitumen recovery rate, or in terms of cost and industrial operability of the method.

The applicant proposed, in international patent application WO 2013/139515, a method for treating oil sand consisting of contacting and mixing the oil sand with a separating fluid at an operating temperature less than or equal to the glass transition temperature of bitumen, the separating fluid having the particular characteristic of being liquid at the operating temperature and operating pressure. It may notably be liquid carbon dioxide. After this contacting and mixing, a solid phase can be separated essentially comprising mineral phase of oil sand and a liquid phase comprising essentially bitumen and the separating fluid. The bitumen is then recovered from this liquid phase. This method of separation has the advantage of being simpler to implement than everything that has been carried out or proposed to date, of being inexpensive, and of allowing recovery of bitumen from an oil sand without using water and at a high yield. However, the inventors discovered that separation of the bitumen and the mineral phase could be further improved.

### SUMMARY OF THE INVENTION

The present invention aims in particular to provide a method for treating oil sands that makes it possible to recover the bitumen at a maximum yield and consequently obtain a clean sand free from bitumen. It is desirable for this method of treatment to be simple to implement, therefore avoiding strictly gas/solid operations with poor performance and in particular unsuitable for the high-tonnage treatment of contaminated products such as oil sands, and in addition should not require techniques that are expensive in energy terms and difficult to implement, such as the methods of deasphalting using heavy solvents, grinding and fine sieving, or centrifugation.

The invention also aims to satisfy at least one of the following aims:
to provide a method that uses little or no water, that uses neither soda, nor polluting additives, and that makes it possible to avoid lagooning;
to provide a method that is easily industrializable, and able to reach a high production capacity and whose exploitation is compatible with the general operating conditions of mining installations;
to provide a method having a high recovery rate of the bituminous phase, which makes it possible to discharge a clean inorganic phase, and notably sand, that may be reincorporated in the ground of the mine;
to provide a method in which the pressure applied is moderate and the low temperature is easy to control by simple regulation of the operating pressures;
to provide a method that produces little or no waste products;
to provide a method allowing easy recovery and recycling of the solvent for extracting the bituminous phase;
to provide a method that is not dangerous to use, notably with respect to the flammability of the materials treated (solvents, flammable powder, etc.).

To achieve at least one of these aims, the present invention proposes, according to a first aspect, a method for treating an oil sand comprising a bituminous phase and an inorganic phase, comprising the steps consisting of:
(1) cooling said oil sand to a temperature below the glass transition temperature of bitumen by bringing said oil sand into contact with carbon dioxide in the solid state and simultaneously supplying mechanical energy to the mixture obtained;
(2) melting the solid carbon dioxide so as to obtain a multiphase system and keeping this multiphase system at a temperature below the glass transition temperature of bitumen;
(3) separating at least one solid phase and at least one liquid phase from this multiphase system;
(4) recovering the bituminous phase from the separated liquid phase.

The present invention also relates to a device for treating oil sand, specially designed for implementing the above method. This device comprises:
at least one contactor for bringing said oil sand into contact with carbon dioxide in the solid state;
at least one means for supplying mechanical energy to the mixture of oil sand with carbon dioxide in the solid state;
a means for melting the carbon dioxide in the solid state present in the mixture to obtain a multiphase system;
at least one separator for separating at least one solid phase and at least one liquid phase from this multiphase system;
at least one means for recovering a bituminous phase from the liquid phase or phases obtained in said separator.

### BRIEF DESCRIPTION OF THE DRAWINGS

FIG. 1 is a schematic illustrating a first embodiment of the invention.

FIG. 2 is a schematic illustrating an alternative embodiment of the invention.

FIG. 3 is a schematic illustrating another embodiment of the invention.

FIG. 4 is a schematic illustrating another embodiment of the invention.

### DETAILED DESCRIPTION OF THE INVENTION

Unless stated otherwise, the pressures given in the present invention are absolute pressures.

The present invention therefore relates to a method of treatment for extracting the bituminous phase from an oil sand. “Oil sand” means, in the present invention, reserves of hydrocarbons consisting of a mixture of heavy oils degraded to bitumens, called “bituminous phase”, and of inorganic matter, called “inorganic phase”. The bituminous phase may typically represent from 5 to 20 wt %/o of the oil sand. The inorganic phase essentially consists of sand, but it may also contain other mineral compounds, such as clays. The oil sand may also contain water.

The oil sand may be obtained by strip mining, and conveyed, for example by a conveyor, from the extraction site to the treatment device.

Before the method of treatment according to the invention is carried out, foreign matter that may be entrained with the oil sand may be removed. The oil sand is typically in the form of grains of millimeter size. Advantageously, the oil sand may be conditioned before treatment thereof according to the invention so that the grains are of a uniform size, for example between 1 millimeter and 3 millimeters.

Innovatively and particularly advantageously, the method for treating oil sand according to the invention uses carbon dioxide (CO₂).

The use of carbon dioxide is interesting, in that it is a product that is very widely available at high purity and at very low cost. Carbon dioxide is for example obtainable from petrochemical platforms (ammonia production, for example) or from refining (unit for production of hydrogen by steam reforming, for example), from natural deposits or from purification of natural gas (decarbonation unit, for example).

Another advantage of carbon dioxide for the present invention is connected with its thermodynamic properties, and with the fact that it is commonly used in all three states: solid, liquid and gaseous. Carbon dioxide may in fact be used very easily in the liquid state, once the pressure is above 5.18 bar, but also in the solid state once the temperature is below −56.6° C. Carbon dioxide may be handled in the solid state (commonly called dry ice) at atmospheric pressure at a temperature of −78.5° C. In practice, liquid carbon dioxide can be stored and transported at low temperature (below −20° C.) and medium pressure (between 5 and 18 bar, for example). It can easily be transformed into a solid, in the form of pellets or beads a few millimeters in diameter using relatively simple industrial installations. These pellets or beads are currently produced on a large scale for certain applications, such as CO₂ sand blasting or cryogenic cleaning.

In the method according to the present invention, pure carbon dioxide may be used. However, it is also envisaged, according to a particular embodiment, to use carbon dioxide that may contain certain impurities, such as notably CH₄, N₂, C₂H₆ and optionally H₂O, Ar, H₂S, SO₂ and NOₓ. The nature and the amount of impurity/impurities in the carbon dioxide may be selected by a person skilled in the art so as not to impede or prevent the production of carbon dioxide in solid form.

In the first step of the method according to the invention, oil sand is brought into contact with carbon dioxide in the solid state. A preferred implementation of the method consists of using solid carbon dioxide in the form of pellets with a size between 1 millimeter and 3 millimeters. The oil sand and the solid carbon dioxide that are brought into contact may advantageously both initially be in the form of grains of comparable size, which optimizes contacting thereof and makes it possible to increase the cooling rate of the oil sand, and therefore the productivity of the method.

This first step of the method according to the invention may be carried out at a pressure between 1 bar and 5 bar, preferably between 1.5 bar and 4.5 bar, and more preferably of about 4 bar. In these operating conditions, the average temperature prevailing in the contactor becomes established at a value depending, on the one hand, on the relative amounts of solid carbon dioxide and of oil sand introduced and on the other hand on the operating pressure. The temperature of the resultant mixture may therefore be between −78.5° C. and −57° C., preferably between −75° C. and −58° C., and more preferably at about −60° C. Contacting the oil sand with carbon dioxide in the solid state makes it possible to cool said oil sand to a temperature below the glass transition temperature of bitumen, which is typically between −15° C. and −40° C., conventionally at about −20° C. This glass transition temperature of bitumen may be measured conventionally using a differential scanning calorimetry (DSC) apparatus. If the bitumen has several glass transition temperatures, the glass transition temperature adopted in the present invention is that which is typically located between −15° C. and −40° C. The temperature to which the oil sand is cooled in this first step notably depends on the manner in which the oil sand is brought into contact with the carbon dioxide in the solid state, and the duration of this contacting. The first step of the method according to the invention may advantageously consist of cooling the oil sand to a temperature below −40° C., preferably below −50° C., and more preferably to a temperature between −75° C. and −57° C., the pressure being maintained at a value below 5 bar and more preferably at about 4 bar.

In this first step, bringing the oil sand into contact with solid carbon dioxide is concomitant with supply of mechanical energy to the oil sand by solid/solid impact with carbon dioxide in the solid state, the hardness and abrasive power of which are known. This supply of energy may be effected in various ways, by techniques familiar to a person skilled in the art. Certain appropriate means of injection may promote collision of the oil sand and carbon dioxide in the solid state and supply sufficient mechanical energy. According to one embodiment of the invention, energy supply is effected by stirring the mixture of oil sand and carbon dioxide in the solid state, as soon as they are brought into contact or afterwards.

The first step of the method according to the invention may be carried out continuously, semicontinuously or in batch mode. The residence time of the oil sand in the device in which it is brought into contact with carbon dioxide in solid form may advantageously be between 5 and 60 minutes, and more preferably between 5 and 30 minutes.

The aim of this first step of the method according to the invention is on the one hand to cool the oil sand to a temperature below the glass transition temperature of bitumen and simultaneously supply sufficient mechanical energy to the oil sand to facilitate separation of the bitumen from the inorganic matter at this temperature.

On exposure to a temperature less than or equal to the glass transition temperature of bitumen, an oil sand may undergo two types of physicochemical effects. On the one hand, it is known that the coefficient of thermal expansion of bitumen is higher than that of a mineral material such as sand or clays. Cooling an oil sand may therefore cause a decrease in the cohesion that exists between the bituminous fraction and the inorganic fraction. In addition, bitumen becomes more brittle than sand, and may therefore break up into particles that are easier to recover. Moreover, it is often assumed that oil sand, especially of Canadian origin, may consist of mineral, and notably of sand grains, surrounded by a film of water, which in its turn is enveloped in a thin layer of bitumen. The cooling of oil sand is thus accompanied by transformation of the water film into a thin film of ice, which may facilitate the phenomenon of spalling and of release of the bitumen.

Supply of mechanical energy, combined with cooling, advantageously makes it possible to break the adhesion of the bitumen to the inorganic matter, and thus detach the layer of bitumen from the inorganic matter. Mechanical energy also allows break-up of the agglomerations of the grains of oil sand that may optionally be agglomerated, or of preventing their agglomeration.

The method according to the present invention differs from the methods described in the prior art notably in that carbon dioxide in the solid state, initially at a temperature below −57° C., is used for cooling the oil sand and to facilitate detachment of the bitumen from the inorganic phase. This contacting is particularly advantageous as it allows very strong cooling of the oil sand by supplying negative calories generated during heating of the solid carbon dioxide as well as by its partial sublimation. The use of a solid refrigerant instead of a liquid or gaseous refrigerant is advantageous because, on the one hand, it is thus possible to cool the oil sand rapidly to very low temperatures, and on the other hand, detachment of the bitumen from the inorganic phase is facilitated by the phenomenon of attrition generated by contact between oil sand and solid carbon dioxide. Moreover, the use of solid carbon dioxide is also advantageous relative to the use of conventional mechanical grinding mills. In fact, pellets of solid carbon dioxide are refrigerants that become more effective as their size is reduced, and have a granulometry close to that of oil sand, and accordingly their sublimation is more rapid. Carbon dioxide also allows easy and efficient recovery of the bituminous phase in the rest of the method according to the invention.

According to a variant of the invention, the first step of the method according to the invention may further comprise addition of carbon dioxide in the liquid state to the mixture comprising oil sand and carbon dioxide, both introduced in the solid state. Preferably, the weight of liquid carbon dioxide added is, however, less than 50% of the weight of the oil sand, and preferably between 10% and 25% of the weight of the oil sand. This addition of carbon dioxide in liquid form may be effected from the start of bringing the oil sand into contact with the carbon dioxide in solid form, or subsequently, once or more than once. Owing to the pressure conditions prevailing in the contactor, the carbon dioxide thus added is in gaseous form. Its expansion and change from the liquid state to the gaseous state supplies additional negative calories, which contribute to maintaining or lowering the temperature of the mixture consisting of oil sand and carbon dioxide in the solid state and in the gaseous state. Adding carbon dioxide in liquid form at the moment of bringing the oil sand into contact with carbon dioxide in the solid state makes it possible, at least temporarily, to advantageously improve heat transfer between the carbon dioxide in the solid state and the oil sand, and thus improve cooling efficiency.

The method according to the invention comprises a second step, which consists of melting the solid carbon dioxide so as to obtain a multiphase system from the mixture obtained from the first step, notably comprising carbon dioxide in the solid state. Fusion of the solid carbon dioxide, which consists by definition of transforming the solid carbon dioxide to liquid carbon dioxide, is obtained by changing the process conditions of pressure and/or temperature.

The change in process pressure and/or temperature may be obtained in various ways.

According to a first embodiment, fusion of the solid carbon dioxide may be carried out in the same device as that in which the first step of bringing into contact and of supplying mechanical energy was carried out. Thus, at the end of the first step of the method according to the invention, the pressure and the temperature within the device may be modified in order to obtain fusion of the solid carbon dioxide. Preferably, the temperature within the vessel or vessels is increased using a conventional heating means until the temperature is between −40° C. and −20° C. The pressure within the vessel or vessels may then reach a level between 10 bar and 20 bar.

Alternatively, the second step of the method according to the invention may require the use of a different device than that in which the first step of bringing into contact and of supplying mechanical energy was carried out. According to a second embodiment, at the end of the first step of the method according to the invention, the mixture comprising the oil sand and the initially solid carbon dioxide is introduced into one or more vessels. During charging, it is preferable to maintain a pressure in this vessel or these vessels slightly lower than that prevailing in the device in which contacting was carried out. After complete charging of the vessel(s), the internal pressure and temperature may then be changed in order to cause fusion of the solid carbon dioxide. Preferably, the temperature within the vessel or vessels is increased using a conventional heating means until the temperature is between −40° C. and −20° C. The pressure within the vessel or vessels may then reach a level between 10 bar and 20 bar.

These first and second embodiments are easy to implement when treatment of the oil sand is carried out discontinuously, in batches. Other embodiments may allow the use of a continuous method.

In particular, according to a third embodiment, fusion of the solid carbon dioxide is gradual. Devices known by a person skilled in the art make it possible to vary the pressure and the temperature of the mixture comprising oil sand and carbon dioxide between inlet and outlet. Thus, in this embodiment, the oil sand is brought into contact with carbon dioxide in the solid form at device inlet, mechanical energy then being supplied to this mixture. Then, during its residence time in the device, the mixture is submitted to variations of pressure and/or of temperature which lead to gradual fusion of the solid carbon dioxide. At the outlet of said device, the carbon dioxide may be partially in liquid form and partially in gaseous form. According to this embodiment, the second step of the method according to the invention may consist of allowing the pressure and/or temperature to vary in the method in such a way that the carbon dioxide passes gradually from the solid state to the liquid state and the gaseous state.

Whatever embodiment is implemented, at the end of this second step the temperature of the multiphase system is preferably between −20° C. and −50° C., and its pressure is preferably between 5 bar and 25 bar, more preferably between 5 bar and 15 bar. Care will be taken to ensure that the multiphase system leaving the second step is maintained at a temperature below the glass transition temperature of bitumen.

At the end of this second step of the method according to the invention, a multiphase system is obtained. This multiphase system comprises at least one solid phase and at least one liquid phase. Said solid phase consists essentially of the inorganic phase of the oil sand. Said liquid phase consists essentially of the bituminous phase of the oil sand and liquid carbon dioxide.

More precisely, the multiphase system obtained at the end of the second step of the method according to the invention may comprise, in the order from the most dense to the least dense:
a solid phase, essentially consisting of the inorganic phase of the oil sand, notably of sand, and of ice crystals;
a dense liquid phase, essentially consisting of liquid carbon dioxide in which a proportion of the hydrocarbons is dissolved;
a less dense, and therefore supernatant, liquid phase essentially consisting of most of the bituminous phase of the oil sand liquefied by a fraction of liquid carbon dioxide dissolved in this phase;
a gas phase, essentially consisting of gaseous carbon dioxide.

In the method according to the invention, the liquid carbon dioxide resulting from fusion of the solid carbon dioxide initially introduced in the method, is therefore used as a separating fluid. This use is advantageous because carbon dioxide in the liquid state has a density higher than the density of the bitumen. Thus, the risk of return of the bituminous phase on contact with the solid phase is reduced. Simple and effective recovery of the bituminous phase is then possible notably by gravity decanting.

The third step of the method of treatment according to the invention consists of separating at least one solid phase and at least one liquid phase from this multiphase system obtained at the end of the second step. During this separation, the multiphase system may be maintained at a temperature between −20° C. and −50° C. and at a pressure between 5 bar and 25 bar, more preferably between 10 bar and 20 bar so as to keep the state of the phases of the system favorable for separation.

This separation step may advantageously be a step of gravity separation. The whole of the liquid phase can be recovered from the mixture. However, if nearly all of the bituminous phase is in the supernatant liquid phase, it is possible to recover only this supernatant liquid phase, without the dense liquid phase. This separation may notably be carried out by mechanical skimming of the liquid phase or by overflow, as is carried out in industrial equipment for primary separation of bitumen.

It is also possible to use a method of hydrocycloning for carrying out this separation.

The solid phase recovered, essentially consisting of the inorganic phase of the oil sand, notably sand, and of ice crystals, is particularly poor in bitumen. Its bitumen content by weight may be below 4%, preferably below 2% and more preferably between 0 and 1%. The sand, thus cleaned, may easily be discharged to the environment, for example reincorporated in the ground of the strip mine, without additional treatment.

When the multiphase system comprises a gas phase, the latter may be separated independently.

The liquid phase isolated may have a very small amount of hydrocarbons, which varies depending on the manner of separation selected. These hydrocarbons may be separated from the carbon dioxide by expansion.

In a fourth step in the method according to the invention, the bituminous phase is recovered from this liquid phase. Any recovery technique known by a person skilled in the art may be used. However, it is particularly advantageous to perform recovery of the bituminous phase by decompression of the separated liquid phase. In fact, simple decompression of the liquid phase makes it possible to cause the carbon dioxide to pass from the liquid state to the gaseous state. Recovery of the bitumen may then be done at a very good yield, using a device that is simple, inexpensive, and does not consume energy.

The bituminous phase thus recovered may be treated subsequently by the conventional techniques of the downstream treatment chain in the surface processes that precede the upgrading conventionally employed for finally converting the bitumen extracted to commercial grade crude oil.

The method according to the invention makes it possible to recover the bituminous phase contained in an oil sand with a recovery rate by weight advantageously between 60% and 95%, more preferably between 75% and 95%. Moreover, the bituminous phase recovered has a content by weight of inorganic matter typically below 5%, more preferably below 2%, and even more preferably between 0 and 1%. It is therefore an efficient method of treatment.

The method according to the invention may further comprise the steps of recovery and of recycling of carbon dioxide.

On the one hand, in the step of separation of the multiphase system, it is possible to recover specifically the dense liquid phase of the multiphase system, essentially consisting of liquid carbon dioxide, and/or the gas phase, essentially consisting of gaseous carbon dioxide, when the latter is present.

On the other hand, in the step of recovery of the bituminous phase, carbon dioxide may be recovered in particular in the gaseous form when recovery was carried out by decompression.

The carbon dioxide thus recovered may be suitably reconditioned and recycled to the method according to the invention. It may notably be recompressed and/or cooled and/or transformed into pellets of solid carbon dioxide. According to one embodiment of the method according to the invention, during the separation step and/or during the recovery step, at least a proportion of the carbon dioxide is recovered, and then transformed into pellets of solid carbon dioxide. However, it will be necessary to ensure that the carbon dioxide recovered does not contain an excessive amount of impurities, which could impede or prevent its conversion to the solid form.

The method according to the invention advantageously comprises a restricted number of unit steps. It also has the advantage that there is no use of makeup water, thus greatly minimizing the problems of existing wastewater treatment and lagooning, and the associated energy consumption.

The method is preferably continuous, which is advantageous for treating the large amounts of oil sands that can only be upgraded by methods of the mining type.

The present invention also relates to a device for treating oil sand, specially designed for implementing the above method. This device comprises:
at least one contactor for bringing said oil sand into contact with carbon dioxide in the solid state;
at least one means for supplying mechanical energy to the mixture of oil sand with carbon dioxide in the solid state;
a means for melting the carbon dioxide in the solid state present in the mixture to obtain a multiphase system;
at least one separator for separating at least one solid phase and at least one liquid phase from this multiphase system;
at least one means for recovering a bituminous phase from the liquid phase or phases obtained in said separator.

The contactor must be suitable for bringing carbon dioxide in the solid state into contact with oil sand. The contactor may be suitable for continuous operation or for batch operation.

In the case of a contactor with batch operation, it is possible for example to use a vessel whose pressure and/or temperature can be controlled. Advantageously, the vessel may be provided with a conical bottom for easy discharge of its contents with maximum efficiency, and which may optionally be equipped with a scraping device.

In the case of a continuous contactor, a pressure vessel may be used of the concrete pump type, which operates in the same pressure range as the method according to the invention. It is also possible to use ascending co-current contactors, directly inspired by the conventional “riser-cracking” technology (in French “craquage en lit transporté ascendant”) of oil refineries, which are well known for their high efficiency of mass and heat transfer, thus minimizing the residence time required for contacting. Conversely, it is also possible to use descending co-current contactors, directly inspired by the “downcomer” technology (in French “tuyau de descente”), also described in chemical engineering publications.

Whatever the operating mode of the contactor, it simultaneously performs the functions of mixing and of supply of mechanical energy to the oil sand by solid/solid impact with solid carbon dioxide. The contactor may notably be provided with an injector allowing powerful impact during contacting of the oil sand with the solid carbon dioxide. In addition or alternatively, the contactor may be of a special design promoting impacts between the oil sand and the solid carbon dioxide. This is so for example in the contactors of the ascending co-current or descending co-current type, in which the oil sand and the solid carbon dioxide collide as soon as they are injected into the contactor and throughout their ascent (or descent, depending on the technology used) in the column.

The device according to the invention may preferably comprise a means for supplying additional mechanical energy to the mixture of oil sand with carbon dioxide in the solid state. This means is adapted to the contactor employed. The choice of means for supplying mechanical energy may determine the power of this energy supply. One means for supplying mechanical energy may consist of a mixer or a stirrer. The stirrers familiar to a person skilled in the art, such as internal screws with or without a guide tube, screws with inclined axis, stirrers of the single-flow or double-flow propeller type, grinding disks, turbines, etc., may be used. A person skilled in the art will notably refer to the equipment described in the following works:
“Agitation et mélange” [Stirring and mixing], C. Xuereb, M. Poux, J. Bertrand, DUNOD publishers, Paris 2006—ISBN 2100497006,
“Perry's Chemical Engineers' Handbook”, D. Green, R. Perry, McGraw-Hill, 8^{th} edition.

It can be seen from the preceding examples that bringing in contact and supply of additional mechanical energy may result from a single device performing both functions. Thus, these means may for example consist of a contactor driven by a motor. Alternatively, a continuous contactor consisting of a pressure vessel, containing one or more rotors driven by a sufficiently powerful motor, makes it possible to provide, simultaneously, the functions of bringing into contact, stirring and pumping of the mixture of oil sand and solid carbon dioxide.

Moreover, the device according to the invention, for implementing the method for treating oil sands, comprises a means for melting the carbon dioxide in the solid state present in the mixture in order to obtain a multiphase system.

This means may consist of systems of valves and pressure sensors in the contactor, for varying the pressure inside the contactor. In addition, this means may consist of heating or cooling systems, notably in the form of a double jacket around the contactor in which a heat-transfer fluid circulates, or in the form of electric heating, and optionally equipped with temperature sensors in the contactor, for monitoring the thermal gain in the contactor. A vessel other than the contactor, intended to receive the mixture of solid carbon dioxide and oil sand after the first step of the method according to the invention, may also be equipped with these means.

In the case of a batch method, these means for melting the carbon dioxide in the solid state may be employed at a given moment, at the end of the first step of the method according to the invention.

However, in the case of a continuous method, these means may consist of a special design of continuous contactor allowing gradual melting of the carbon dioxide between its inlet point in the contactor and its outlet. A special design may be sufficient to ensure melting of the carbon dioxide. It may, however, be combined with a more conventional means for controlling the temperature and/or pressure, such as a double heating jacket or electric heating.

For example, in the case of a contactor of the concrete pump type, equipped with rotor(s) simultaneously performing the functions of contacting, stirring and pumping, the mixture comprising at inlet the oil sand and solid carbon dioxide gradually moves toward the outlet of the contactor. During this gradual movement, its pressure increases. The mixture thus compressed may also be heated by contact with the wall of the drum of the contactor, the temperature of which can be adjusted by the heat-transfer fluid circulating in a double jacket. As a result, the solid carbon dioxide gradually melts and the carbon dioxide recovered at the outlet of this continuous contactor is in liquid form and, in certain cases, partially gaseous. This is also the case with contactors of the ascending co-current or descending co-current type, in which the state of fusion and/or of sublimation of the carbon dioxide is connected with the design of these contactors, in which the mixture of oil sand and solid carbon dioxide is heated spontaneously or optionally forced by contact with the wall of the contactor, whose temperature may be regulated by external heat supply, for example by means of a double jacket or electric heating.

The device according to the invention further comprises at least one separator for separating at least one solid phase and at least one liquid phase from the multiphase system. Any type of liquid/solid separators known by a person skilled in the art may be used in the device according to the invention.

The separator may be a multiphase gravity decanter, as commonly used in the oil industry. The decanter is preferably equipped with means for heating and depressurization.

In a simple embodiment, the contactor and the separator are the same devices. They may notably be mixer-settlers that are well known from the prior art in the field of chemical engineering. In another embodiment, the separator is a different device located downstream of the contactor. The device may comprise several separators arranged in parallel so as to be able to adjust a residence time in the separator independently of the residence time of the products in the contactor.

Alternatively, the separator may be a hydrocyclone.

Finally, the device according to the invention further comprises at least one means for recovery of the bituminous phase from the separated liquid phase. Advantageously, as it is simple and inexpensive, the means for recovery may consist of a flask supplied with liquid phase equipped with means for decompression and for recovery of the liquid bituminous phase on the one hand and the gas phase on the other hand. In a particular embodiment, a device for supplementary heating is combined with the decompression device.

The device according to the invention may advantageously comprise elements for providing recovery and recycling of the carbon dioxide. The device may notably comprise a machine for making pellets of solid carbon dioxide. This machine may be fed with the carbon dioxide recovered from the separator and/or from the recovery means, and with makeup of fresh carbon dioxide.

Certain particular embodiments of the method according to the invention are explained below, using the appended figures.

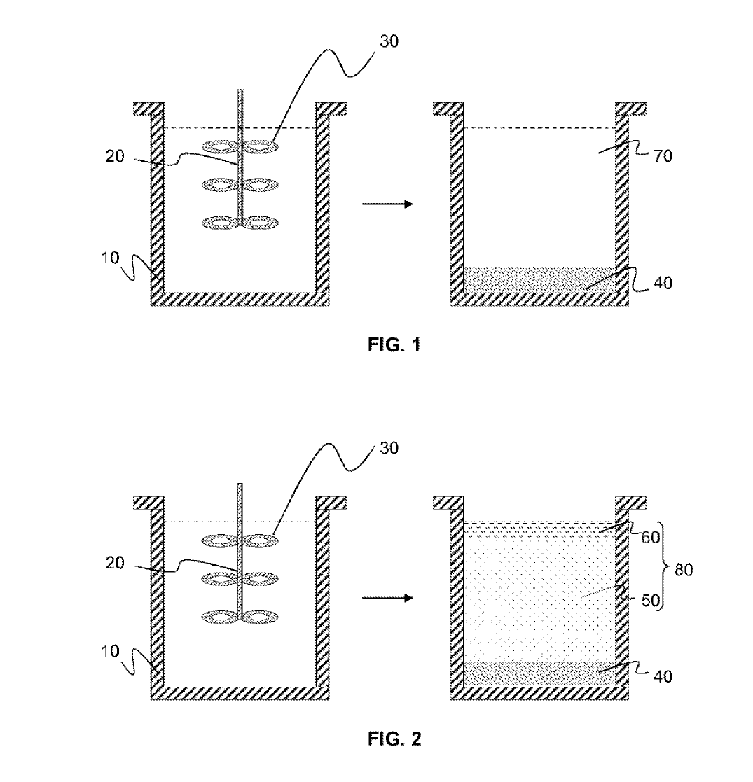

FIG. 1 illustrates an embodiment of the method according to the present invention that may function in continuous, semicontinuous or batch mode.

In this embodiment, the device consists of four main items of equipment: a contactor 1, a decanter 2, an evaporator 3 and a machine 4 that produces pellets of dry ice.

On the one hand the oil sand 5, which has previously been sorted and optionally calibrated in millimeter particle size, and on the other hand pellets of solid carbon dioxide (CO₂) 6, also of millimeter size, are introduced in a discontinuous, semicontinuous or continuous stream into the contactor 1 maintained at a pressure preferably equal to 4 bar. Vigorous mechanical stirring is applied in this contactor 1 by means of a stirrer 7 equipped with a scraping device adapted to the shape of the bottom of the contactor, which may be conical, elliptical or some other shape. The stirrer is rotated by the motor 8. Contacting, and supply of mechanical energy in this contactor 1 are carried out at a temperature close to −60° C. The oil sand is thus cooled rapidly to a very low temperature, well below the glass transition temperature T_{g} of bitumen (close to −20° C.), which facilitates detachment of the bitumen phase from its inorganic matrix and also promotes attrition of the solid bitumen released. The residence time of the oil sand in this contactor 1 is favorably between 1 and 60 min and more favorably between 5 and 30 min.

The contactor is then emptied of its contents via the conical bottom 9 and the mixture is then introduced into a decanter 2, which also has a conical bottom. A single decanter 2 is shown in FIG. 1. However, it is possible for the device to comprise several decanters 2 arranged in parallel. During filling of decanter 2, the pressure within the latter is kept slightly lower than that prevailing in the contactor 1.

After complete charging of decanter 2, its temperature is increased by a heating means, which is not shown (double jacket supplied with heat-transfer fluid, or electric heating) until its temperature is between −40° C. and −20° C. We thus obtain fusion of the CO₂ pellets previously introduced, and a resultant pressure level between 10 and 20 bar.

In these conditions, the appearance of four phases is noted, which it will be possible to separate by the effect of gravity:
a denser solid phase 10, essentially consisting of sand and ice crystals;
a dense liquid phase 11, essentially consisting of liquid CO₂;
a supernatant liquid phase 12, especially consisting of bitumen, and liquefied by a fraction of liquid carbon dioxide dissolved in this phase;
a gas phase 13, essentially consisting of gaseous CO₂.

When decanting has ended, i.e. after a residence time that may be between 5 and 60 min, the solid phase 10 is evacuated via the bottom of decanter 2 and recovered via line 14.

The supernatant liquid phase 12 is recovered at the outlet of decanter 2 in line 15 to be fed into the evaporator 3. The bitumen that is comprised in this liquid phase 12 is recovered by decompression in evaporator 3, which is equipped with a control valve 16 controlled by a pressure regulator 17. The bitumen is recovered via line 18, whereas the CO₂ in gaseous form is recovered at the outlet of the evaporator via line 19.

The dense liquid phase 11, essentially consisting of liquid CO₂, is recovered at the outlet of decanter 2 via line 20, which is connected to the machine 4 via line 46 leaving filter 45 for removing the fine particles of mineral and of solidified hydrocarbons. The gas phase 13, essentially consisting of gaseous CO₂, is recovered via line 23 and valve 21, which is controlled by a pressure regulator 22. All the liquid or gaseous CO₂ is recovered and returned via lines 19, 23 and 46 to machine 4 that makes the CO₂ pellets, which is also supplied with a makeup of liquid CO₂ from cryogenic storage 24. The pellets produced in machine 4 are fed via line 6 into the contactor 1.

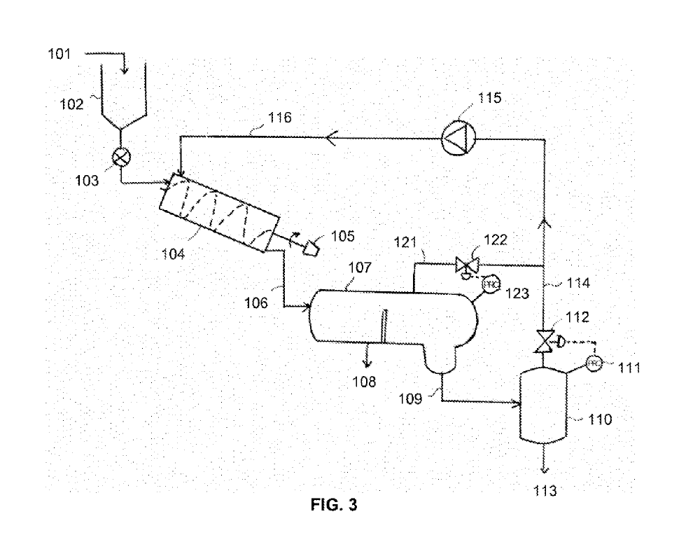

FIG. 2 illustrates an embodiment of the method according to the present invention that can operate advantageously in a continuous mode, which is preferable for satisfying industrial needs for the treatment of oil sands, the aim of the present application.

This embodiment is identical to that shown in FIG. 1, apart from the contactor. In fact, in the embodiment shown in FIG. 2, the oil sand to be treated 25 and the pellets of solid CO₂ 26 are introduced into a continuous contactor 27 consisting of a receiving drum under pressure, equipped with a double jacket 28 in which a heat-transfer fluid circulates at a temperature between −25° C. and −40° C. This receiving drum contains one or more rotors 29, simultaneously performing the functions of stirring and of pumping, driven by a motor 30 of sufficient power to convey the mixture of oil sand and solid CO₂ to a decanter 2. As the mixture of oil sand and of solid CO₂ advances to the outlet 31 of contactor 27, its pressure increases. The mixture thus compressed is lightly heated by contact with the wall of the drum of the contactor, whose temperature is controllable by the heat-transfer fluid circulating in the double jacket 28. As a result, the solid CO₂ gradually melts and the mixture obtained at outlet 31 may be fed into the decanter 2 and form four phases, similarly to the case described in FIG. 1.

The machine for making CO₂ pellets is not shown in FIG. 2, but it may form part of the device.

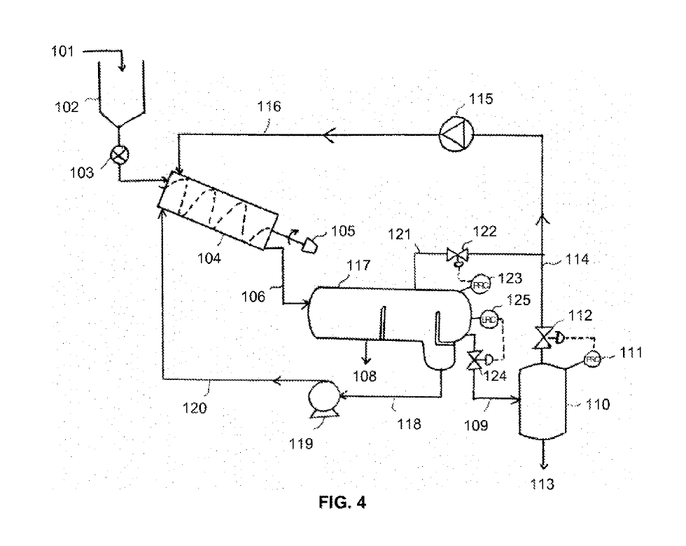

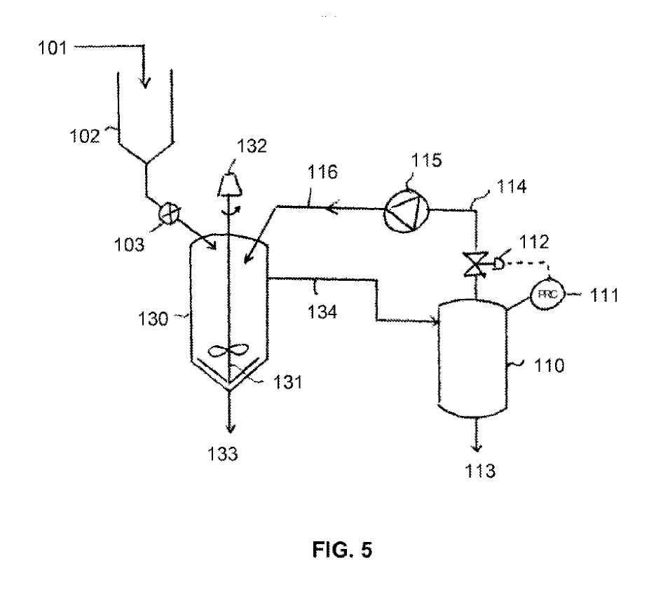

FIGS. 3 and 4 illustrate schematically other embodiments of the method, allowing quick and efficient contact between the oil sand and pellets of solid CO₂.

In FIG. 3, the device comprises a descending co-current contactor 35. The oil sand 32 and pellets of solid CO₂ 33 obtained directly from the pelletizing unit 43 are brought into contact at the inlet of contactor 35. CO₂ in liquid form is also introduced into the contactor 35 via line 34. The contactor 35 is equipped with a heating means 36 ensuring fusion of the solid CO₂. Located downstream of this contactor 35, a hydrocyclone separator 37 makes it possible to obtain, at the bottom of the cyclone, a purified sand recovered via line 38 and, at the top, a mixture of bitumen and liquid and gaseous CO₂ recovered via line 39. This mixture is fed into an evaporator 40. The bitumen is recovered by decompression via line 41, whereas the CO₂ in gaseous form is recovered at the outlet of the extractor 40 via line 42. It is returned to the machine 43 making the CO₂ pellets.

In FIG. 4, the device is identical to that described in FIG. 3 except that the contactor is an ascending co-current contactor of the riser type 44.

Other aims, features and advantages of the invention will become clear from the following examples, which are given purely for illustration and are not in any way limiting.

### EXAMPLES

### Example 1

### The Case of Cryogenic Grinding and Sieving Cooled Conventionally and without Addition of Separating Fluid

This example makes it possible to verify that cryogenic grinding and sieving without addition of separating fluid only leads to a method of treatment with limited performance.

The work was carried out with an oil sand that contained 0.4% of water and, after drying, contained 11 wt % of bitumen and 89% of mineral material. Various samples of this oil sand were submitted to an operation of cryogenic grinding and sieving. For this purpose, the work was carried out in an air-conditioned room at −25° C. and all the instruments used during the experiments that were carried out: grinding mill, sieve, tweezers, spatulas, etc., were cooled beforehand with liquid nitrogen.

The grinding mill used was of the rotary impact type made by the company Fritsch, of the “Pulverisette 14.702” type. The rotary speed of the grinding mill was maintained at 15 000 revolutions per minute.

Immediately on completion of cryogenic grinding, the ground and recovered product was submitted to separation by passage through a stack of sieves corresponding to mesh diameters equal to the following values: 250 μm, 160 μm, 100 μm and 50 μm.

Each test was carried out using an initial weight of 156 g of dry oil sand, making it possible to recover, from this initial weight of material, 5 fractions corresponding to the granulometric ranges (0-50), (50-100), (100-160), (160-250) and 250+ μm.

The results of this test are presented in Table 1:

TABLE 1

| Granulometric | Weight of the | Corresponding |
|---|---|---|
| fraction | fraction recovered | weight of bitumen |
| (μm) | (g) | (g) |
| 0-50 | 3 | 1.8 |
| 50-100 | 21 | 7.3 |
| 100-160 | 22 | 5.2 |
| 160-250 | 59 | 2.7 |
| 250+ | 51 | 1.4 |

It can be seen from this table that a method of cryogenic grinding-sieving is conceivable for obtaining a certain bitumen enrichment of the finer granulometric fractions but that this enrichment can only be exploited if we accept discarding an appreciable proportion of the raw material that still contains bitumen. In fact it is found that, starting for example from 100 tonnes of oil sand containing 11% of bitumen, it may appear interesting to produce 29.5 tonnes of sand of granulometry 0-160 μm and containing on average 31% of bitumen (therefore richer than the raw material), but this involves discarding 70.5 tonnes of sand containing 3.7% of bitumen. It should be noted that this method only leads to a bitumen-enriched mineral phase and not to a mineral-free bitumen, which requires the application of an additional treatment for recovery of bitumen so that it can be sent to the upgrading chain. Moreover, if despite everything we wish to continue with separation of bitumen by this technique, it would be necessary to envisage recycling the enriched fraction in a new operation and at each passage an appreciable fraction of sand still containing bitumen will have to be discarded. Such a method applied to the scale of industrial requirements for upgrading oil sands is therefore difficult to envisage both because its bitumen yield is low, and because of the difficulty of operation and the high cost of the latter.

On attempting to apply this same technique to another grade of oil sand (the case of a sand containing only 5% of bitumen and 10% of water), it was found that the enrichment observed for the fractions of fine granulometry (0-100 μm) is much more limited.

### Example 2

### The Case of Cryogenic Grinding and Sieving Cooled with Solid or Liquid CO₂ but without the Presence of a Separating Fluid

In this case, the nature of the oil sand submitted to the experiment is the same as previously, i.e. containing, after drying, 11% of bitumen and 89% of inorganic material. The grinding mill is also of the Fritsch rotary type, “Pulverisette 14702”.

But this time, instead of permanently cooling the laboratory to −25° C. and the equipment temporarily with liquid nitrogen, the grinding mill was put in an atmosphere cooled by supplying an initial weight of solid CO₂ and purging with gaseous CO₂, also cooled. The temperature of the grinding mill during operation could thus be maintained at about −30° C. As soon as grinding was finished, the resultant oil sand was recovered in an atmosphere consisting of gaseous CO₂ resulting from the change of state of the solid CO₂ initially introduced to cold gaseous CO₂ and liquid CO₂, which itself transformed into gaseous CO₂, also cold. Sieving of the oil sand ground in these conditions was carried out as before with a stack of vibratory sieves corresponding to the same mesh diameters, but also under purging with cooled gaseous CO₂, as was carried out for grinding.

Table 2 presents the results obtained for 152 g of sieved product.

TABLE 2

| Granulometric | Weight of the | | Corresponding |
|---|---|---|---|
| fraction | fraction recovered | % bitumen in the | weight of bitumen |
| (μm) | (g) | fraction recovered | (g) |
| 0-50 | 3 | 58 | 1.7 |
| 50-100 | 20 | 36 | 7.2 |
| 100-160 | 19 | 14 | 2.7 |
| 160-250 | 54 | 6 | 3.2 |
| 250+ | 56 | 3.5 | 2.0 |

Once again it can be seen that this operation makes it possible to recover 42 g of a 0-160 μm fraction containing 28% of bitumen but that this enrichment is effected at the cost of discarding 110 g of a 160 μm+ fraction that still contains 4.7% of bitumen.

This experiment therefore shows that, regardless of the method of cooling with which the method of enrichment based on embrittlement and breakage below the glass transition temperature of the bitumen is carried out, of the bond between this bitumen and the mineral part (in this case carried out by grinding and sieving, the principle of which is similar to that based on patent application US 2011/0297586), the result is the same once a separating fluid such as liquid CO₂ is not kept present as a separating fluid throughout the steps of the method. As was observed in example 1, this method only leads to a bitumen-enriched mineral phase and not a mineral-free bitumen.

### Example 3

### Extraction According to the Invention

Learning from the unsatisfactory results of examples 1 and 2, we tried to reproduce experimentally the method according to the invention on laboratory equipment used conventionally for visualization of thermodynamic equilibria at high pressure, consisting of a transparent cell of about 50 cm³ (sapphire tube with height of 100 mm and inside diameter of 25 mm) placed in an enclosure that could maintain the temperature of the cell at a fixed value by controlled injection and expansion of carbon dioxide. A stirring rotor with a vertical axis is arranged at the bottom of the cell. An external system makes it possible to circulate the fluid (CO₂) through the cell and adjust the pressure to a fixed value.

Three types of oil sands (OS) were employed. The composition of these oil sands is shown in Table 3 below (in wt %):

TABLE 3

| Sample | % Bitumen | % Water | % Mineral matter |
|---|---|---|---|
| OS A | 12.4 | 5.5 | 82.1 |
| OS B | 9.1 | 5.8 | 85.1 |
| OS C | 5.9 | 11.3 | 82.8 |

The test sample (15 g) and pellets of dry ice (40 g) were put at the bottom of the cell. Vigorous stirring was then switched on and was maintained for 20 minutes. The pressure in the cell increases slowly from 1 to 5 bar absolute and the temperature measured at the bottom of the cell becomes established at about −50° C. Then the stirrer was stopped and the phases decanted slowly. The pressure in the cell and the temperature measured at the bottom of the cell increased slowly from 5 to 14 bar absolute and from −50° C. to −30° C. respectively. Four phases clearly appeared:
a residue is deposited at the bottom of the cell,
a slightly brown, very fluid, dense liquid phase,
a dark viscous supernatant phase,
a colorless gas phase.

These various phases were then recovered and analyzed after removal of the CO₂ by expansion at atmospheric pressure. Recovery of the hydrocarbons dissolved in the dense liquid fluid phase, essentially consisting of liquid CO₂, did not allow reliable quantification. The supernatant phase is recovered in the form of a viscous black liquid, essentially consisting of hydrocarbons and not containing mineral. However, it is probable that a proportion of the bituminous phase that separated anyway during the operation is redeposited on the residue during this experimental separation, reducing by that much measurement of the level of bitumen effectively separated from the mineral phase.

The three charges were treated in our installation and the degrees of extraction of the bitumen (in wt %) are presented in Table 4 below:

TABLE 4

| Sample | Estimated recovery rate of the bitumen, % |
|---|---|
| OS A | 27 |
| OS B | 28 |
| OS C | 36 |

Despite the underestimation of the degree of extraction of the bitumen resulting from the limits of the method of measurement employed, it can be seen that the method consisting of combining strong cooling of the oil sand with vigorous mechanical stirring of the mixture of oil sand with pellets of dry ice leads to heavy attrition of the layer of bitumen surrounding the mineral phase and thus makes it possible to recover the hydrocarbons present in the oil sand.

### Example 4

### Extraction According to the Invention

In a variant of the preceding test, initially we deposited 15 g of sand and 25 g of pellets of dry ice in the cell. The pressure in the cell increased slowly from 1 to 5 bar absolute and the temperature measured at the bottom of the cell was established at about −48° C. After stirring for 10 min, about 5 g of supercooled liquid CO₂ was introduced by passing through a coil maintained in a bath at −40° C. It can then be seen that a large proportion of this fluid was vaporized instantaneously on entering the cell. The pressure was maintained at 5 bar absolute and the temperature stabilized at around −55° C. Stirring was stopped after 20 min and the phases decanted slowly with appearance of the four phases as previously. The pressure in the cell and the temperature measured at the bottom of the cell increase slowly from 5 to 15 bar absolute and from −50° C. to −34° C., respectively.

The results measured as in example 3 are as follows:

TABLE 5

| Sample | Estimated bitumen recovery rate, % |
|---|---|
| OS A | 34 |
| OS B | 33 |
| OS C | 44 |

We may therefore legitimately think that the use of optimized means for implementing the method according to the invention will make it possible to obtain hydrocarbons present in the oil sand at a high degree of extraction, noting that the bitumen thus recovered is mineral-free and may therefore be fed into the upgrading chain without additional treatment.

### Example 5

### Comparative Example

This comparative example presents an experimental verification of the advantage of performing the extraction of the bituminous phase from oil sands (OS) by a method consisting firstly of bringing the oil sand into contact with pellets of solid CO₂ while making a significant supply of mechanical energy to the mixture and then introducing liquid CO₂ into this mixture, which allows liquefaction of all the CO₂ present, for a sufficient time and at a temperature below the glass transition temperature of bitumen, so that—finally—the bituminous phase is effectively separated from the inorganic phase (sand) containing it. This bituminous phase may then finally be recovered, for example by gravity separation, from the multiphase mixture created: inorganic phase/liquid CO₂/bitumen.

Two experiments were therefore carried out and reproduced in the laboratory, each consisting of a succession of several steps, carried out in all cases with a weight of 200 g of one and the same grade of oil sand (OS) containing 11 wt % of bitumen, 83 wt % of inorganic phase and 6 wt % of water.

The first experiment employed the principle of the method described in patent application WO 2013/139515.

Liquid CO₂ was fed into a 2-liter conical-bottom cylindrical reactor containing 200 g of oil sand and equipped with a mechanical stirrer with a vertical axis, fitted with 5 stages of inclined horizontal blades necessary for homogenizing the liquid CO₂/oil sand mixture. This solid/liquid contacting was carried out semicontinuously since the liquid CO₂ was introduced continuously at the bottom of the reactor and in large excess (about 10 g liquid CO₂/1 g oil sand). This operation, which took 100 minutes, made it possible to perform, simultaneously, on the one hand holding the liquid CO₂/oil sand mixture at a total pressure of 10 bar and a constant temperature of −40° C. and on the other hand—owing to mechanical stirring at a fixed rotary speed of 420 rev/min, contact of the oil sand with the liquid CO₂ that is as intimate as possible.

At the end of the experiment, the treated oil sand was recovered from the empty reactor after decompression of the equipment, and then analyzed for its bitumen content. The latter was typically equal to 7.5 wt %, which signifies that the method of bitumen extraction was only 32% efficient.

A second experiment was carried out in two steps.

The first step consisted, as before, of putting 200 g of the same oil sand (OS) in the same reactor and adding 500 g of solid CO₂, introduced manually in the form of commercially available pellets of cylindrical shape, having an average diameter of 3 mm and an average length of 5 mm. The reactor was then closed and the total pressure was then 1 bar.

The stirring rotor was then started up at the same speed as before (420 rev/min) and the time of this solid/solid contacting at very low temperature (close to the temperature of the CO₂ pellets: −78° C.) was adjusted to 10 minutes.

After the 10 minutes of this first step of contact, accruing strong cooling of the sand and strong dissipation of mechanical energy from the bituminous sand/solid CO₂ system, the second step of this second experiment was carried out, the procedure being strictly identical to that described in the first experiment.

At the end of this second experiment, the purified oil sand was recovered as was done before and the residual bitumen content of this sand was measured and was typically found equal to 5.3%.

This signifies that this second experiment made it possible to reach a bitumen extraction rate from the initial oil sand of 52%.

Comparison of the results obtained in the two experiments that have been described therefore allows us to confirm that by preceding the method described in patent application WO 2013/139515 with prior contacting of the oil sand with solid CO₂ combined with strong dissipation of mechanical energy was a very favorable factor for improving the bitumen extraction rate from oil sands.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A process for treating a bituminous sand comprising a mineral fraction and a bitumen fraction and comprising the following steps:
(1) bringing into contact, and mixing in a container, the bituminous sand with a separating fluid present in the liquid state at the operating temperature and at the operating pressure, the operating temperature being below or equal to the glass transition temperature of the bitumen between −15° C. and −40° C.;
(2) separating the solid phase comprising essentially the mineral fraction from the liquid phase comprising essentially the bitumen and the separating fluid;
(3) extracting the bitumen included in the liquid phase.

2. The process as claimed in claim 1, wherein the operating temperature is between −20° C. and −65° C. and the operating pressure is between 5 bar and 25 bar.

3. The process as claimed in one of the preceding claims, wherein the separating fluid is carbon dioxide.

4. The process as claimed in either of claims 1 and 2, wherein the separating fluid is a pure compound or a mixture of compounds belonging to the family of refrigerants.

5. The process as claimed in one of the preceding claims, wherein the separating fluid has a greater affinity for the bitumen than for the sand.

6. The process as claimed in one of the preceding claims, wherein the step of separating the liquid phase and the solid phase is a gravity separation step carried out in a settler.

7. The process as claimed in claim 6, wherein the separating fluid is chosen with a density greater than the density of the bitumen but lower than the density of the sand.

8. The process as claimed in one of the preceding claims, wherein, in the extraction step, the bitumen included in the liquid phase is extracted by evaporation of the separating fluid.

9. The process as claimed in claim 8, wherein the contacting step is carried out under pressure, and wherein the extraction step is carried out by expansion of the separating fluid.

10. The process as claimed in one of the preceding claims, wherein the supernatant liquid phase obtained at the end of the separation step is heterogeneous and comprises a surface layer containing most of the bitumen and a clear liquid phase containing essentially the separating fluid in the liquid state.

11. The process as claimed in claim 10, wherein the extraction step is carried out by mechanical skimming.

12. The process as claimed in one of the preceding claims, wherein the contacting step and the separation step are carried out using the same device.

13. The process as claimed in claim 12, wherein the device is equipped with heating and depressurization means.

14. The process as claimed in one of the preceding claims, additionally comprising a step of recovering the separating fluid.

15. The process as claimed in claim 14, wherein the separating fluid is recovered by depressurization and/or heating of the supernatant liquid phase.
